(19) United States
(12) Patent Application Publication
(10) Pub. No.: US 2023/0214815 A1
(43) Pub. Date: Jul. 6, 2023

(54) TRANSACTION METHOD, TERMINAL DEVICE, PAYMENT SYSTEM, MERCHANT SYSTEM, AND STORAGE MEDIUM

(71) Applicant: CHINA UNIONPAY CO., LTD., Shanghai (CN)

(72) Inventors: Zheng ZHANG, Shanghai (CN); Wenbin QI, Shanghai (CN); Hua CAI, Shanghai (CN); Sishuang WAN, Shanghai (CN)

(21) Appl. No.: 17/928,542

(22) PCT Filed: Sep. 7, 2021
(86) PCT No.: PCT/CN2021/116932

§ 371 Date: Nov. 29, 2022

(30) Foreign Application Priority Data
Oct. 23, 2020 (CN) 202011145031.8

(51) Int. Cl. G06Q 20/32; G06Q 20/40; G06Q 20/38

(52) U.S. Cl. CPC G06Q 20/3255; G06Q 20/401; G06Q 20/3829

(57) ABSTRACT

A transaction method, a terminal device, a payment system, a merchant system, and a storage medium. The transaction method comprises: generating a payment request (101); sending the payment request in a rich media message format to a payment system (102); and receiving a payment processing result in a rich media message format from the payment system, wherein the payment processing result corresponds to the payment request (104). A user can make payment by sending and receiving rich media messages without needing to install multiple payment applications, thereby enabling convenient operation.

The present application claims priority to Chinese Patent Application No. 202011145031.8, filed on Oct. 23, 2020, and entitled “TRANSACTION METHOD, TERMINAL DEVICE, PAYMENT SYSTEM, MERCHANT SYSTEM, AND STORAGE MEDIUM”, the entire contents of which are incorporated herein by reference.

### TECHNICAL FIELD

The present application belongs to the field of electronic commerce, in particular relates to a transaction method, a terminal device, a payment system, a merchant system, a transaction system and a computer-readable storage medium.

### TECHNICAL BACKGROUND

This section is intended to provide background or context for the embodiments of the present application as recited in claims. The description herein cannot be regarded as prior art by virtue of its inclusion in this section.

In general, a user needs to download and install shopping applications to shop for goods or services and download and install payment applications to make payments. In addition, the user may generally install multiple payment applications on a mobile phone. Thus, there is a need for a transaction method to facilitate the operations of the user.

### SUMMARY OF THE INVENTION

For the problems in the prior art, embodiments of the present application provide a transaction method, a terminal device, a payment system, a merchant system, a transaction system and a computer-readable storage medium to at least partially solve the problems.

Embodiments of the present application provide a transaction method, which is applicable to a terminal device and includes:
generating a payment request;
sending the payment request in a rich media message format to a payment system; and
receiving a payment processing result in the rich media message format from the payment system, where the payment processing result corresponds to the payment request.

In some possible embodiments, the method further includes: acquiring payment verification information, and sending the payment verification information in the rich media message format to the payment system, where the payment verification information corresponds to the payment request.

In some possible embodiments, generating the payment request includes:
acquiring order-related information;
sending the order-related information in the rich media message format to a merchant system;
receiving order information in the rich media message format from the merchant system, where the order information is generated by the merchant system based on the order-related information; and
generating the payment request based on the order information;
where sending the payment request in the rich media message format to the payment system specifically includes sending the payment request in the rich media message format to the merchant system to enable the merchant system to send the payment request to the payment system.

In some possible embodiments, the method further includes:
generating a first merchant identification code randomly;
determining an encryption key, and encrypting the first merchant identification code with the encryption key to acquire an identity code;
sending the identity code in the rich media message format to the payment system to enable the payment system to decrypt the identity code and thereby acquire a second merchant identification code, where the payment system is capable of decrypting the identity code; and
sending the order-related information in the rich media message format to the merchant system upon receiving a message that the identity code in the rich media message format sent by the payment system is successfully received;
where sending the payment request in the rich media message format to the merchant system to enable the merchant system to send the payment request to the payment system includes: sending the payment request and the first merchant identification code in the rich media message format to the merchant system to enable the merchant system to send the payment request and the first merchant identification code to the payment system.

In some possible embodiments, sending the order-related information in the rich media message format to the merchant system upon receiving the message that the identity code in the rich media message format sent by the payment system is successfully received specifically includes: sending the order-related information and the identity code in the rich media message format to the merchant system upon receiving the message that the identity code in the rich media message format sent by the payment system is successfully received;

receiving the order information in the rich media message format from the merchant system specifically includes: receiving the order information and the identity code in the rich media message format from the merchant system;

sending the payment request in the rich media message format to the merchant system to enable the merchant system to send the payment request to the payment system specifically includes: sending the payment request, the first merchant identification code and the identity code in the rich media message format to the merchant system to enable the merchant system to send the payment request and the first merchant identification code to the payment system.

In some possible embodiments, the method further includes:
acquiring authorization information, where the authorization information includes: a communication account of the terminal device, identification information of the terminal device, and merchant account information of a user in the merchant system;
sending the authorization information to the merchant system to enable the merchant system to send the authorization information to a messaging platform, where communication between any two of the terminal device, the merchant system and the payment system is relayed by the messaging platform; and
reacquiring authorization information when the user logs into the merchant system, and sending the reacquired authorization information to the messaging platform for the messaging platform to perform login verification.

In some possible embodiments, the method further includes:
acquiring authorization information, where the authorization information includes: a communication account of the terminal device, identification information of the terminal device, and merchant account information of a user in the merchant system;
sending the authorization information to the merchant system to enable the merchant system to send the authorization information to a messaging platform, such that the messaging platform stores the authorization information, where communication between any two of the terminal device, the merchant system and the payment system is relayed by the messaging platform; and
reacquiring authorization information upon sending the payment request in the rich media message format to the merchant system, and sending the reacquired authorization information as to the merchant system to enable the merchant system to send the reacquired authorization information to the messaging platform, thereby allowing the messaging platform to perform payment verification.

Embodiments of the present application provide a transaction method, which is applicable to a payment system and includes:
acquiring a payment request in a rich media message format from a terminal device;
processing the payment request, and acquiring a payment processing result; and
sending the payment processing result in the rich media message format to the terminal device.

In some possible embodiments, the method further includes:
acquiring payment verification information in a rich media message format from the terminal device, and verifying the payment verification information, where the payment verification information corresponds to the payment request; and
processing the payment request under a condition that the payment verification information passes verification.

In some possible embodiments, the method further includes:
acquiring from the terminal device an identity code corresponding to the payment request, and decrypting the identity code to acquire a second merchant identification code; and
comparing a first merchant identification code carried in the payment request with the second merchant identification code, and processing the payment request under a condition that the first merchant identification code is identical with the second merchant identification code, where acquiring the payment request in the rich media message format from the terminal device includes acquiring the payment request in the rich media message format and the first merchant identification code from the terminal device.

In some possible embodiments, the method further includes:
acquiring from the terminal device an identity code corresponding to the payment request, and decrypting the identity code to acquire a second merchant identification code; and
decrypting the identity code carried in the payment request to acquire a third merchant identification code, comparing the third merchant identification code with a first merchant identification code carried in the payment request and the second merchant identification code, and processing the payment request under a condition that the third merchant identification code, the first merchant identification code and the second merchant identification code are identical, where acquiring the payment request in the rich media message format from the terminal device includes acquiring the payment request in the rich media message format, the first merchant identification code and the identity code from the terminal device.

Embodiments of the present application provide a transaction method, which is applicable to a merchant system and includes:
acquiring order-related information in a rich media message format from a terminal device;
generating order information based on the order-related information, and sending the order information in the rich media message format to the terminal device;
acquiring from the terminal device a payment request in a rich media message format corresponding to the order information;
sending the payment request to a payment system;
acquiring from the payment system a payment processing result corresponding to the payment request; and
processing the order information based on the payment processing result, and sending the acquired order processing result in a rich media message format to the terminal device.

In some possible embodiments, acquiring from the terminal device the payment request in the rich media message format corresponding to the order information includes: acquiring from the terminal device the payment request in the rich media message format and a first merchant identification code corresponding to the order information; and

sending the payment request to the payment system includes: sending the payment request and the first merchant identification code to the payment system.

In some possible embodiments, acquiring the order-related information in the rich media message format from the terminal device includes: acquiring the order-related information in the rich media message format and an identity code from the terminal device;

sending the order information in the rich media message format to the terminal device includes: sending the order information and the identity code in the rich media message format to the terminal device;
acquiring from the terminal device the payment request in the rich media message format corresponding to the order information includes: acquiring from the terminal device the payment request in the rich media message format corresponding to the order information, the first merchant identification code and the identity code; and
sending the payment request to the payment system includes: sending the payment request, the first merchant identification code and the identity code to the payment system.

In some possible embodiments, the method further includes: receiving authorization information from the terminal device, and sending the authorization information to a messaging platform for the messaging platform to perform login verification, where the authorization information includes a communication account of the terminal device, identification information of the terminal device, and merchant account information of a user in the merchant system, and where communication between any two of the terminal device, the merchant system, and the payment system is relayed by the messaging platform.

In some possible embodiments, the method further includes:
receiving authorization information from the terminal device, and sending the authorization information to a messaging platform for the messaging platform to perform payment verification, where the authorization information includes a communication account of the terminal device, identification information of the terminal device, and merchant account information of a user in the merchant system, and where communication between any two of the terminal device, the merchant system, and the payment system is relayed by the messaging platform;
where sending the payment request to the payment system includes: sending the payment request and the authorization information to the messaging platform for the messaging platform to verify the authorization information and send the payment request to the payment system under a condition that the authorization information passes verification.

Embodiments of the present application provide a terminal device, which includes at least one first processor, and a first memory communicatively connected to the at least one first processor; where the first memory stores first instructions executable by the at least one first processor, and the first instructions are executed by the at least one first processor to enable the at least one first processor to perform the above transaction method applicable to the terminal device.

Embodiments of the present application provide a payment system, which includes at least one second processor, and a second memory communicatively connected to the at least one second processor; where the second memory stores second instructions executable by the at least one second processor, and the second instructions are executed by the at least one second processor to enable the at least one second processor to perform the above transaction method applicable to the merchant system.

Embodiments of the present application provide a merchant system, which includes at least one third processor, and a third memory communicatively connected to the at least one third processor; where the third memory stores third instructions executable by the at least one third processor, and the third instructions are executed by the at least one third processor to enable the at least one third processor to perform the above transaction method applicable to the payment system.

Embodiments of the present application provide a transaction system including the above terminal device and the above payment system.

In some possible embodiments, the transaction system further includes the above merchant system.

Embodiments of the present application provide a computer-readable storage medium storing programs, that when executed by a processor, cause the processor to perform the transaction method applicable to the terminal device, the transaction method applicable to the merchant system, or the above transaction method applicable to the payment system.

At least one of the technical solutions used in the present application can achieve following beneficial effects. The user only needs to install an application that handles rich media messages on his/her terminal device and can make payments by sending or receiving the rich media messages. For different payment systems, the only difference merely is the “recipient” of the rich media message. This greatly simplifies the user operation and improves the user experience.

It should be noted that the above description is only a summary of the technical solutions of the present application, so that technical means of the present application can be more clearly understood, thereby implementing the present application according to the contents described in the specification. The detailed description of the present application is specifically exemplified below to make the above and other objects, features, and advantages of the present application more clearly understood.

### BRIEF DESCRIPTION OF THE DRAWINGS

The advantages and benefits described herein, and other advantages and benefits will be apparent to those of ordinary skill in the art by reference to the following detailed description. The accompanying drawings are for the purpose of illustrating exemplary embodiments only and are not intended to be a limitation of the present application. Further, a same reference numeral indicates a same component throughout the accompanying drawings. In the accompanying drawings:

FIG. 1a is a schematic diagram of an overall architecture of a transaction system according to an embodiment of the present application;

FIG. 1b is an architectural diagram of a rich media messaging application running on a terminal device according to an embodiment of the present application;

FIG. 2a is a schematic flowchart of a transaction method applicable to a terminal device according to an embodiment of the present application;

FIG. 2b is a schematic flowchart of a transaction method applicable to a payment system according to an embodiment of the present application;

FIG. 3 is a detailed schematic flowchart for generating a payment request in a transaction method applicable to a terminal device according to an embodiment of the present application;

FIG. 4 is a schematic flowchart of a transaction method applicable to a merchant system according to an embodiment of the present application;

FIG. 5 is a schematic diagram for an interaction process of a transaction method according to an embodiment of the present application;

FIG. 6 is a schematic flowchart of a transaction method applicable to a terminal device according to an embodiment of the present application;

FIG. 7 is a schematic diagram for an interaction process of a transaction method according to an embodiment of the present application;

FIG. 8 is a schematic flowchart for verifying information by a terminal device in a transaction method according to an embodiment of the present application;

FIG. 9 is a schematic diagram for acquiring authorization information by a messaging platform in a transaction method according to an embodiment of the present application;

FIG. 10a, FIG. 10b and FIG. 10c are examples of messaging session interfaces according to embodiments of the present application;

FIG. 11 is a schematic structural diagram of a terminal device according to an embodiment of the present application;

FIG. 12 is a schematic structural diagram of a merchant system according to an embodiment of the present application; and

FIG. 13 is a schematic structural diagram of a payment system according to an embodiment of the present application.

In the accompanying drawings, the same or corresponding reference signs indicate same or corresponding portions.

### DETAILED DESCRIPTION OF THE EMBODIMENTS

Exemplary embodiments of the present disclosure will be described below in more detail with reference to the accompanying drawings. Although the accompanying drawings illustrate exemplary embodiments of the present disclosure, it should be understood that the present disclosure can be implemented in various forms and should not be construed as limited to embodiments described herein. Rather, these embodiments are provided so that the present disclosure will be understood thoroughly, and will fully convey the scope of the present disclosure to those skilled in the art.

In the present disclosure, it should be understood that terms such as “including” or “having” are intended to indicate the presence of the features, numbers, steps, actions, components, parts or a combination thereof as disclosed by the specification, and does not exclude the possibility to include one or more other features, numbers, steps, actions, components, parts or a combination thereof.

Furthermore, it should be noted that the embodiments of the present disclosure and features of the embodiments may be combined with each other as long as they are not contradictory. The present disclosure will be described in detail below with reference to the accompanying drawings and embodiments.

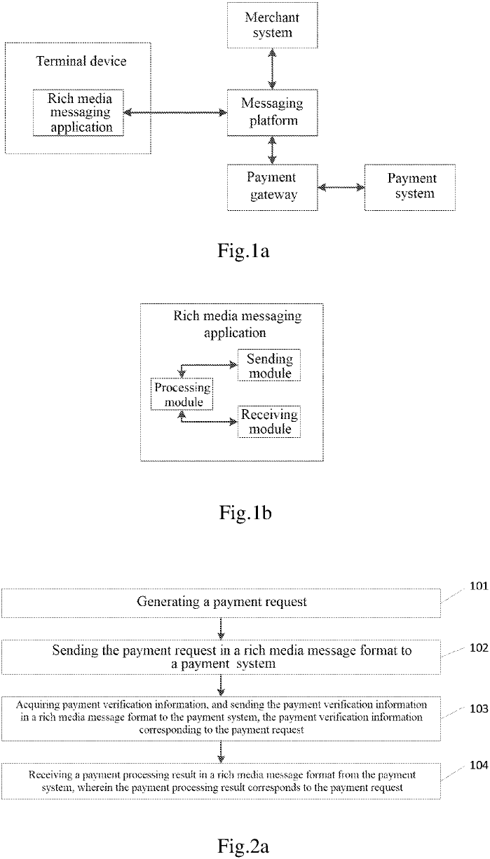

Referring to FIG. 1a, the transaction system according to the embodiment of the present application includes a terminal device (e.g., a smartphone), a merchant system (e.g., a backend server of an e-commerce platform), a payment system (e.g., a backend server of UnionPay® or a backend server of a third-party payment provider or a backend server of a mobile wallet such as Huawei Pay), and a messaging platform (e.g., a MaaP messaging platform, Massage as a Platform).

The terminal device is installed with a rich media messaging application capable of sending and receiving rich media messages (also referred to as 5G messages). The rich media messaging application may display a merchant messaging session interface, such that the user is allowed to exchange rich media messages with the merchant system. The rich media messaging application may also display a payment messaging session interface, such that the user is allowed to exchange rich media messages with the payment system.

FIG. 1b illustrates a software architecture of a rich media messaging application, which includes a sending module, a receiving module, and a processing module. The sending module is configured to send a rich media message externally, and the party ultimately receiving the rich media message may be a terminal device where another cell-phone number is located, or may be a merchant system or payment system. The receiving module is configured to receive the rich media message, and the party sending the rich media message may be a terminal device where another cell-phone number is located, or may be a merchant system or payment system. The processing module may perform certain logical processing on the rich media message sent or received.

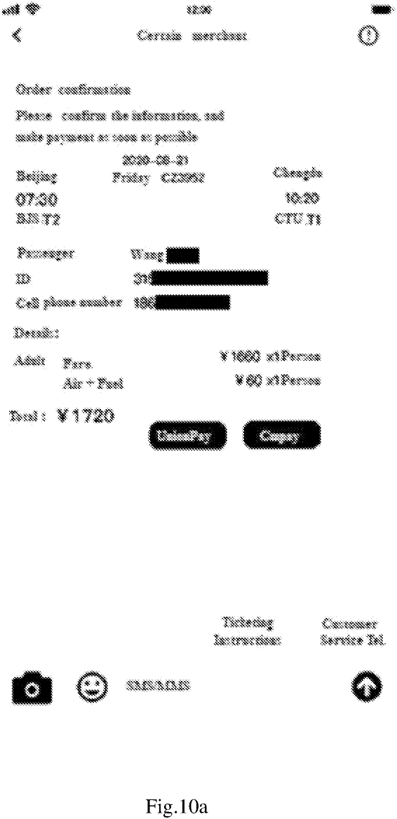

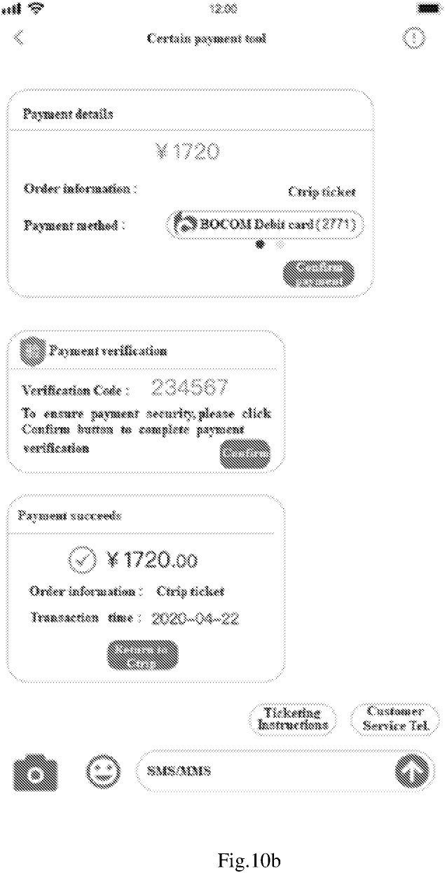

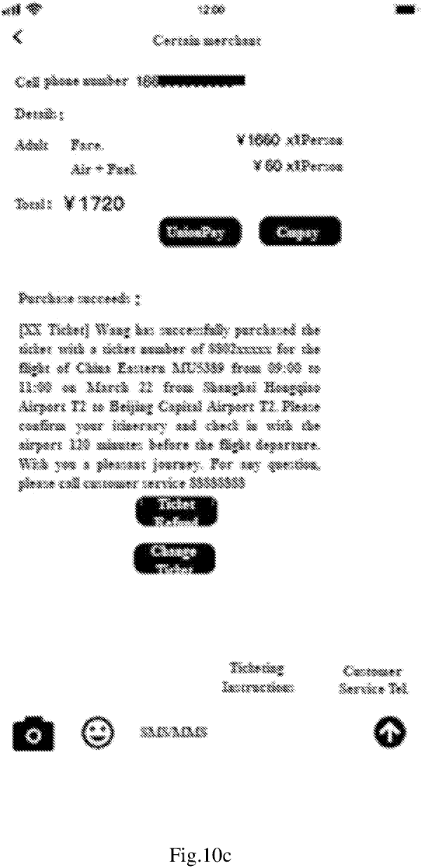

The interface on the terminal device for displaying transceiving of the rich media message with the merchant system is referred to as the merchant messaging session interface, referring to FIG. 10a and FIG. 10c. The interface on the terminal device for displaying transceiving of the rich media message with the payment system is referred to as the payment messaging session interface.

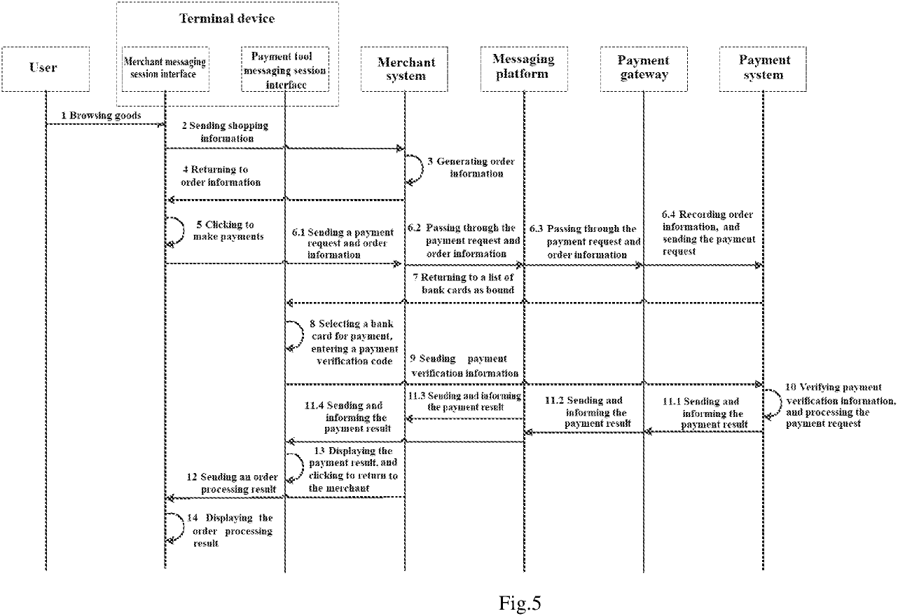

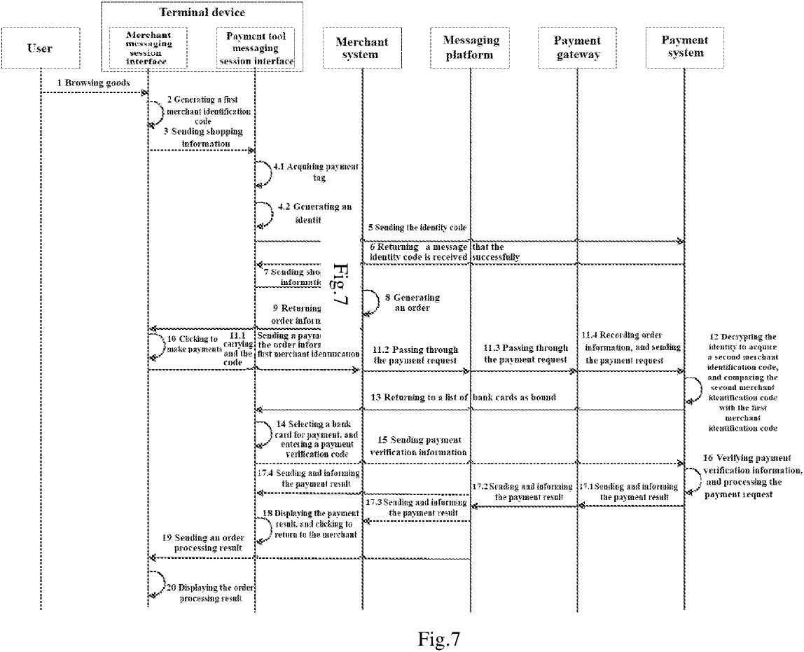

In the interaction flowcharts illustrated in FIG. 5 and FIG. 7, the operations corresponding to the merchant messaging session interface represent the processing logic of the rich media messaging application for transceiving of the rich media message with the merchant system, and the operations corresponding to the payment messaging session interface represent the processing logic of the rich media messaging application for transceiving of the rich media message with the payment system.

In an example of the present application, the rich media messages sent between the terminal device and the merchant system are relayed via the messaging platform, the rich media messages sent between the terminal device and the payment system are relayed via the messaging platform, and the rich media messages sent between the merchant system and the payment system are also relayed via the messaging platform.

In another variation, the rich media messages sent between the terminal device and the merchant system are relayed via the messaging platform, the rich media messages sent between the terminal device and the payment system are relayed via the messaging platform, and the communication between the merchant system and the payment system is achieved by other means (e.g., via the Internet).

In an example, a payment gateway is provided between the payment system and the messaging platform, and the payment gateway may serve as a frontend device for a plurality of different payment systems to record transaction information associated with the payment information. It is obvious that, the respective different payment systems may also communicate directly with the messaging platform without going through the payment gateway.

It should be noted that the rich media message communication between the terminal device and the merchant system in FIG. 5 and FIG. 7 is also relayed via the messaging platform, and the relay steps via the messaging platform are omitted to make the flowcharts more concise.

In another variation of the transaction system, the transaction system includes the terminal device, messaging platform and payment system in FIG. 1a, and does not include the merchant system and payment gateway. Thus, the transaction system herein mainly handles payment-related operations and does not involve operations such as shopping. In this variation, the transaction system, for example, is capable of handling services such as money transfers.

In another variation of the transaction system, the transaction system still includes the merchant system, but the communication between the merchant system and the terminal device may be a 5G communication network, 4G communication network, wireless network (wifi), or the like. In this variation, a shopping application is installed on the terminal device, and configured to trigger a payment tool in the rich media messaging application to generate a payment request.

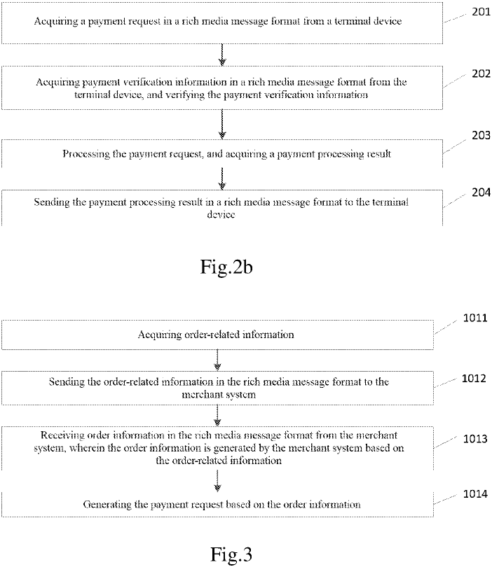

FIG. 2a is a schematic flowchart of a transaction method according to an embodiment of the present application. The method is configured to enable a user to complete a payment by sending a rich media message. In this process, the executing subject may be a terminal device from the perspective of a device; and from the perspective of a program, the executing subject may accordingly be a program carried on the terminal device, in particular an application for transceiving and processing the rich media message.

The flow in FIG. 2a may include following steps 101 to 104.

Step 101: generating a payment request.

Specifically, the payment request may be generated by the rich media messaging application in the terminal device based on the user operation, or may be for example generated by a shopping application in the terminal device based on the user operation.

Step 102: sending the payment request in a rich media message format to a payment system.

Specifically, the rich media messaging application in the terminal device sends the payment request to the payment system in response to the user operation.

Step 103: acquiring payment verification information, and sending the payment verification information in the rich media message format to the payment system, where the payment verification information corresponds to the payment request.

For example, the user needs to enter SMS verification code, payment password, registered fingerprint, or captured facial image in the payment messaging session interface of the terminal device. The terminal device then sends the payment verification information in the rich media message format to the payment system, such that the payment system verifies the payment request.

Referring to step 8 in FIG. 5, in the rich media messaging application on the terminal device, the user is prompted to enter payment verification information in the messaging session interface of the payment tool for the session with the payment system.

In some payment systems, the user may bind a plurality of bank cards, and the user is required to select the bank card for payment at this time. In step 7 of FIG. 5, the payment system may send a list of bank cards bound by the user to the terminal device via the messaging platform, and then displays the list of bank cards in the payment messaging session interface to thereby allow the user to select the bank card.

Referring to FIG. 10b, in an example, the rich media messaging application of the terminal device may display an interface for selecting a bank card in the payment messaging session interface.

Referring to FIG. 10b, in an example, the rich media messaging application of the terminal device may display an interface for entering payment verification information in the payment messaging session interface.

It is obvious that, in some variations, the step 103 may be omitted, and the terminal device may for example be authorized for a password-free payment.

Step 104: receiving a payment processing result in the rich media message format from the payment system, where the payment processing result corresponds to the payment request

For example, the rich media messaging application on the terminal device displays the payment processing result showing whether the payment succeeds or fails in the payment messaging session interface.

In conjunction with FIG. 5, the payment system may send the payment processing result to the terminal device via the messaging platform, such that the payment processing result is displayed in the payment messaging session interface of the terminal device.

The user only needs to install an application that handles rich media messages on his/her terminal device and can make payments by sending or receiving the rich media messages. For different payment systems, the only difference is the “recipient” of the rich media message. This greatly simplifies the user operation and improves the user experience.

Based on the same inventive concept, referring to FIG. 2b, embodiments of the present application corresponding to the above embodiment further provide a transaction method applicable to the payment system. The method includes following steps 201 to 204.

Step 201: acquiring a payment request in a rich media message format from a terminal device

Step 202: acquiring payment verification information in a rich media message format from the terminal device, and verifying the payment verification information, where the payment verification information corresponds to the payment request (in some scenarios of password-free payment, the step 202 may be omitted, and the payment system ensures security of the payment by other means).

In conjunction with step 9 in FIG. 5, the rich media messaging application in the terminal device may send the payment verification information to the payment system. The payment system processes the payment request only when the payment verification information passes verification.

The payment verification information may, for example, be SMS verification code, payment password, fingerprint information, facial image information, etc.

It is obvious that, under a condition that the payment system is directly debiting the bank card and the user has bound a plurality of bank cards in the payment system, the payment system should also send card selection information to the terminal device. Accordingly, the rich media messaging application of the terminal device may thus display the operation interface of card selection in the payment messaging session interface.

Step 203: processing the payment request, and acquiring a payment processing result

Step 204: sending the payment processing result in the rich media message format to the terminal device.

Each of the different payment systems may interact with the terminal device by the communication in the rich media message form to complete the payment. In this way, the operations of terminal user can be simplified, so that the terminal user can avoid the tedious operation of installing different payment applications.

For example, referring to FIG. 10b, the payment messaging session interface of the terminal device may display the payment processing result. Further, the merchant system may accordingly process the order upon acquiring the payment processing result, and may for example enable the order to take effect under a condition that the payment succeeds.

Some of the following embodiments are extensions of the preceding embodiments. For example, in some scenarios, the rich media messaging application installed in the terminal device can exchange rich media messages with the merchant system to enable the shopping for goods or services and thus initiate the above payment process. From the perspective of the terminal device, referring to FIG. 3, the process of generating the payment request in the transaction method includes following steps 1011 to 1014.

Step 1011: acquiring order-related information.

In conjunction with step 1 in FIG. 5, the user initiates a session with the merchant system in the rich media messaging application. The merchant messaging session interface is an interface where the user interacts with the merchant system. This is similar to an SMS session interface where the user sends and receives short messages to another cell-phone user in an SMS application. The user may browse and shop for goods or services from the merchant messaging session interface.

The order-related information includes, for example, product name, product quantity, product money, or the like. Under the condition that the merchant system is a shopping platform, that is, there are a plurality of merchants thereon, the order-related information may further include the merchant number of the merchant in the merchant system.

The order-related information also needs to include information that identifies the user, such as the cell phone number, the identification information of the terminal device, the user’s account registered with the merchant system (referred to as the merchant account in the present application), or the like.

Step 1012: sending the order-related information in the rich media message format to the merchant system.

In conjunction with step 2 in FIG. 5, the user may for example click a “Buy Now” button in the merchant messaging session interface, such that the terminal device sends the order-related information to the merchant system. Then, the merchant system may generate an order based on the information.

Step 1013: receiving order information in the rich media message format from the merchant system, where the order information is generated by the merchant system based on the order-related information.

In conjunction with step 4 in FIG. 5, the merchant system may send the order information to the rich media messaging application. The merchant system herein may determine a recipient account (i.e., the receipt account of the merchant in the payment system) for the merchant number based on the merchant number in the order-related information.

Step 1014: generating the payment request based on the order information.

In conjunction with step 5 in FIG. 5, the rich media messaging application may receive the order information, and then generate a payment request based on the amount of money and the recipient account in the order information. The rich media messaging application may be capable of interfacing with a plurality of payment systems. Thus, a plurality of buttons may be provided in the merchant messaging session interface to direct to different payment systems. The payment request is processed by the corresponding payment system for whichever button the user taps.

For example, referring to FIG. 10a, the user may click a “UnionPay” button on the merchant messaging session interface, such that the payment request is eventually sent to the UnionPay® payment system.

In this embodiment, the payment request in the rich media message format is forwarded by the terminal device to the payment system via the merchant system.

Further, the transaction method may further include: receiving from the merchant system an order processing result corresponding to the order information. Accordingly, the order processing result may be displayed in the merchant messaging session interface of the rich media messaging application of the terminal device.

Specifically, the payment system may further send the payment processing result to the merchant system via the messaging platform. The merchant system may acquire the order processing result corresponding to the order information based on the payment processing result, and then sends the order processing result to the terminal device via the messaging platform, and the terminal device displays the order processing result in the merchant messaging session interface.

For example, after viewing in the payment messaging session interface the prompt message carrying that the payment succeeds, the user may click a confirm button, such that the interface jumps to the merchant messaging session interface, and the user may see a prompt message that the payment of his/her shopping order has completed in the merchant messaging session interface.

Referring to FIG. 10b, in an example, the rich media messaging application of the terminal device displays in the payment messaging session interface a rich media message carrying that the payment succeeds.

Referring to FIG. 10c, in an example, the rich media messaging application of the terminal device displays in the merchant messaging session interface a rich media message carrying that the order is processed successfully (e.g., the ticket purchase succeeds).

It is obvious that, in some variations, the payment system may also send the payment processing result in an SMS message form to the user via an SMS platform; and the merchant system may also send the order processing result in the SMS message form to the user via the SMS platform. This is based on a fact that one piece of the available identifying information of the terminal device is the cell phone number regardless of whether the application is an SMS application or a rich media messaging application.

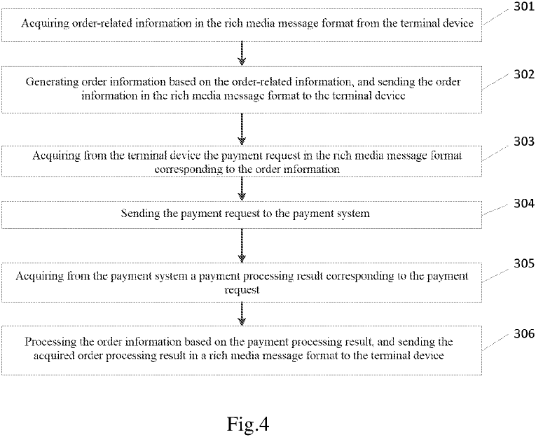

Based on the same inventive concept, embodiments of the present application further provide a transaction method applicable to the merchant system to thereby cooperate with the rich media messaging application on the terminal device to complete the shopping for goods or services and the processing of orders. Referring to FIG. 4, the transaction method includes following steps 301 to 306.

Step 301: acquiring order-related information in the rich media message format from the terminal device.

In conjunction with step 3 in FIG. 5, the rich media messaging application on the terminal device sends the order-related information to the merchant system.

Step 302: generating order information based on the order-related information, and sending the order information in the rich media message format to the terminal device.

In conjunction with step 4 in FIG. 5, the merchant system may send the order information to the terminal device, such that the order information is displayed in the merchant messaging session interface of the rich media messaging application on the terminal device.

Step 303: acquiring from the terminal device the payment request in the rich media message format corresponding to the order information.

In conjunction with step 6.1 in FIG. 5, the rich media messaging application on the terminal device may send the payment request to the merchant system.

Step 304: sending the payment request to the payment system.

In conjunction with steps 6.2-6.4 in FIG. 5, the merchant system may send the payment request to the messaging platform, such that the messaging platform sends the payment request to the payment gateway, and the payment gateway sends the payment request to the payment system.

In some optimized solutions, the merchant system may carry the order information while sending the payment request, such that the payment gateway may record the order information when the messaging platform sends the payment request and the order information to the payment gateway. As a result, the payment gateway may count and manage the order information.

Thus, the merchant system can initiate orders and payments to the user simply by exchanging the rich media message with the terminal device, which can also simplify operations of the user.

Step 305: acquiring from the payment system a payment processing result corresponding to the payment request

Step 306: processing the order information based on the payment processing result, and sending the acquired order processing result in a rich media message format to the terminal device.

Referring to FIG. 5, in steps 11.1-11.3, the payment system may send the payment processing result in the rich media message form to the transaction system. In step 12, the order processing result acquired by the transaction system based on the payment processing result is sent to the terminal device, such that the user is allowed to see the order processing result in the merchant messaging session interface. FIG. 10c illustrates an example of a merchant messaging session interface displaying the order processing result.

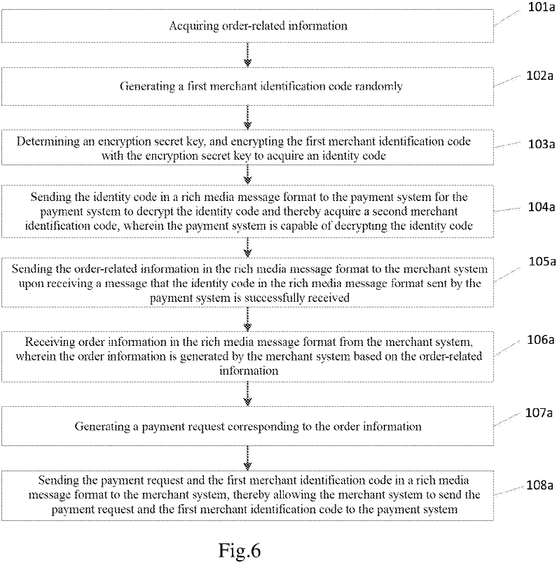

Referring to FIG. 6, embodiments of the present application further provide a transaction method applicable to a terminal device, which is a further optimization of the above transaction method. FIG. 7 is a schematic diagram of the interaction flow corresponding to the optimization. The parts of the transaction method are the same as those in the preceding embodiment will not be repeated. The transaction method includes following steps 101a to 108a.

Step 101a: acquiring order-related information.

Step 102a: generating a first merchant identification code randomly.

In conjunction with step 2 in FIG. 7, in the rich media messaging application on the terminal device, a processing program corresponding to the merchant messaging session interface may randomly generate a merchant identification code. The first merchant identification code varies with the different orders.

Step 103a: determining an encryption key, and encrypting the first merchant identification code with the encryption key to acquire an identity code.

In conjunction with steps 4.1 and 4.2 in FIG. 7, the processing program corresponding to the payment messaging session interface of the rich media messaging application on the terminal device may acquire the encryption key and encrypt the merchant identification code with the encryption key.

In an example, the encryption key may be a payment token generated by the payment system corresponding to the payment messaging session interface for a bank card of the user. The payment token is a string of codes that corresponds to a unique bank card.

Optionally, the payment token may be generated at the payment system and then sent to the rich media messaging application of the terminal device, or may be pre-stored by the rich media messaging application of the terminal device. Obviously, the merchant system and the corresponding processing program of the merchant messaging session interface are unaware of what payment tokens are used by the payment messaging session interface.

Under a condition that the user has bound more than one bank card to the payment system, the payment token corresponding to the bank card on which the payment is to be made in priority may be selected.

It is obvious that, the processing program corresponding to the payment messaging session interface of the rich media messaging application on the terminal device may also encrypt the first merchant identification code with the asymmetric encrypting manner.

In an example, the rich media messaging application may send the order-related information to the merchant system, the merchant system then sends the order-related information to the payment system, and the payment system sends the order-related information to the terminal device, such that the processing program processing the payment messaging session interface is triggered to acquire the payment token.

In another example, the internal logic of the rich media messaging application of the terminal device allows the processing program corresponding to the merchant messaging session interface to directly trigger the processing program corresponding to the payment messaging session to acquire the payment token (or to acquire another type of key).

Step 104a: sending the identity code in the rich media message format to the payment system to enable the payment system to decrypt the identity code and thereby acquire a second merchant identification code, where the payment system is capable of decrypting the identity code.

Referring to step 5 in FIG. 7, the rich media messaging application on the terminal device may send the identity code to the payment system. The relaying steps as performed by the messaging platform and the payment gateway are omitted to make FIG. 7 more concise.

Step 105a: sending the order-related information in the rich media message format to the merchant system upon receiving a message that the identity code in the rich media message format sent by the payment system is successfully received.

For example, referring to step 6 in FIG. 7, the payment system may send to the rich media message application on the terminal device a message that the identity code is successfully received, and the processing program corresponding to the payment messaging session interface of the rich media message application is responsible for processing the logic of sending the order-related information to the merchant system.

Step 106a: Receiving order information in the rich media message format from the merchant system, where the order information is generated by the merchant system based on the order-related information.

Referring to steps 8 and 9 in FIG. 7, the merchant system may generate an order based on the order-related information, and then send the order information to the rich media messaging application on the terminal device, such that the order information is processed by the corresponding processing program on the merchant messaging session interface of the rich media messaging application.

Step 107a: generating a payment request corresponding to the order information.

Step 108a: sending the payment request and the first merchant identification code in the rich media message format to the merchant system, thereby allowing the merchant system to send the payment request and the first merchant identification code to the payment system.

Referring to steps 11.1-11.4 in FIG. 7, the processing program corresponding to the merchant messaging session interface in the rich media messaging application on the terminal device may run to send the payment request and the first merchant identification code to the merchant system, and the merchant system then forwards them to the payment system.

The payment system may compare the received first merchant identification code with the second merchant identification code acquired by decrypting the received identity code, and it is determined that the verification is passed under a condition that the two merchant identification codes are identical, thereby enabling to process the payment request.

The first merchant identification code is generated by the processing program corresponding to the merchant messaging session interface in the terminal device, and is always stored at the terminal device, and the cipher text of the first merchant identification code is merely sent externally at step 5 in FIG. 7. Under a condition that an illegal merchant intercepts the order information sent by the merchant system in step 9 of FIG. 7, the payment system will not process the payment request initiated by the illegal merchant because the payment system is not informed of the merchant identification code. Even if the illegal merchant meanwhile intercepts the step 5 in FIG. 7, the illegal merchant may be difficult to decrypt and acquire the first merchant identification code because what is transmitted in the step 5 is the cipher text of the identity code, i.e., the first merchant identification code. Accordingly, the security of the transaction is improved.

For the terminal device, the operations after step 108a are the same as those in the previous embodiment and will not be repeated.

Based on the same inventive concept, the above transaction method applicable to the merchant system is optimized to include: receiving the payment request in the rich media message format and the first merchant identification code from the terminal device, and sending the received payment request and the first merchant identification code to the payment system.

Based on the same inventive concept, the above transaction method applicable to the payment system is optimized to include: receiving the identity code from the terminal device and decrypting the identity code to acquire the second merchant identification code; receiving the first merchant identification code while receiving the payment request; comparing the first merchant identification code with the second merchant identification code, and processing the payment request under a condition that the first merchant identification code and the second merchant identification code are identical.

A first variation of the above optimization solution will be described below.

In conjunction with FIG. 7, in step 7 of FIG. 7, the processing program corresponding to the payment messaging session interface of the terminal device sends purchase information (i.e., order-related information) and the identity code to the merchant system.

In step 9 of FIG. 7, the merchant system sends the order information and the identity code to the processing program corresponding to the merchant messaging session interface of the terminal device.

In step 11.1 of FIG. 7, the processing program corresponding to the merchant message session processing interface of the terminal device sends the order information (which can be omitted), the first merchant identification code, the identity code, and the payment request to the merchant system.

In step 11.2 of FIG. 7, the merchant system sends the order information, the first merchant identification code, the identity code, and the payment request to the messaging platform.

In step 11.3 of FIG. 7, the messaging platform passes through the order information, the first merchant identification code, the identity code, and the payment request to the payment gateway.

In step 11.4 of FIG. 7, the payment gateway records the order information and sends the first merchant identification code, the identity code, and the payment request to the payment system.

In step 12 of FIG. 7, the payment system re-decrypts the received identity code to acquire a third merchant identification code, and then compares the third merchant identification code, the received first merchant identification code, and the previously stored second merchant identification code to determine whether they are identical. The verification passes under a condition that the three merchant identification codes are identical, and the payment request is subsequently processed.

Similarly, under a condition that the illegal merchant intercepts the step 9 in FIG. 7, the illegal merchant cannot forge the correct first merchant identification code, such that the initiated payment request will not be processed by the payment system. Even if the illegal merchant acquires a pair of first merchant identification code and identity code, the illegal merchant may fail to determine the specific merchant identification code to which the currently intercepted order information corresponds, and thereby may fail to initiate an illegal payment request. Accordingly, the payment security is further improved.

A second variation of the preceding optimization scheme will be described below.

In step 5 of FIG. 7, the processing program corresponding to the payment messaging session interface of the terminal device sends both of the merchant identification code and the identity code to the payment system, where the processing program corresponding to the payment messaging session interface herein performs a first type of encryption processing on the identity code.

In step 7 of FIG. 7, the processing program corresponding to the payment messaging session interface of the terminal device sends the order-related information, the merchant identification code and the identity code together to the merchant system, where the processing program corresponding to the payment messaging session interface herein performs a second type of encryption processing on the identity code.

In step 8 of FIG. 7, the merchant system performs a third type of encryption processing on the identity after the second type of encryption.

In step 9 of FIG. 7, the merchant system sends the order information, the merchant identification code and the identity code by the third type of encryption to the processing program corresponding to the merchant messaging session interface of the terminal device.

In step 11.1 of FIG. 7, the processing program corresponding to the merchant messaging session interface of the terminal device decrypts the identity code to acquire a second encrypted identity code, and then sends the payment request, the second encrypted identity code and the merchant identification code to the merchant system.

In step 11.2 of FIG. 7, the merchant system sends the merchant identification code, the second encrypted identity code, and the payment request to the messaging platform.

In step 11.3 of FIG. 7, the messaging platform then passes through the merchant identification code, the second encrypted identity code, and the payment request to the payment gateway.

In step 11.4 of FIG. 7, the payment gateway passes through the merchant identification code, the second encrypted identity code, and the payment request to the payment system.

In step 12 of FIG. 7, the payment system looks up the stored first encrypted identity code based on the received merchant identification code, then decrypts the first encrypted identity code and the second encrypted identity code respectively, and compares to determine whether the two decrypted identity codes are identical. The verification passes under a condition that the two decrypted identity codes are identical.

In this encryption method, although the merchant identification code is plaintext, the identity code is encrypted with a different encryption method in each transmission.

Even if the illegal merchant intercepts the second encrypted identity code and merchant identification code in step 9, the illegal merchant does not know the first encrypted identity code corresponding to the merchant identification code, and therefore cannot initiate an illegal payment request.

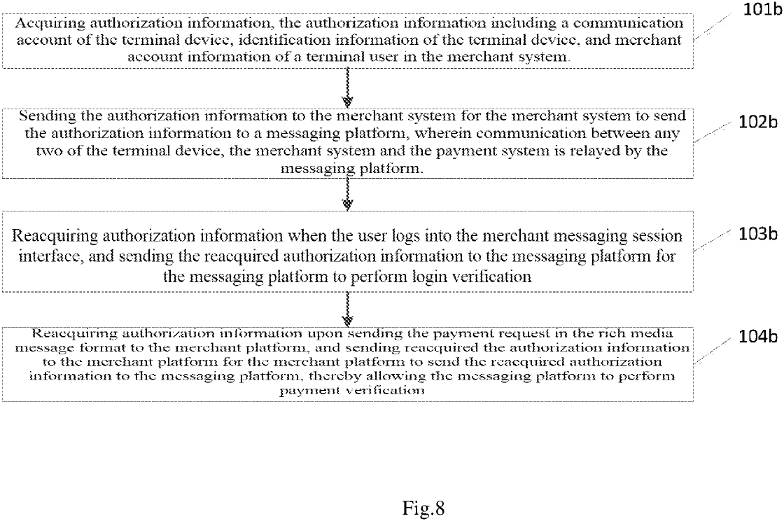

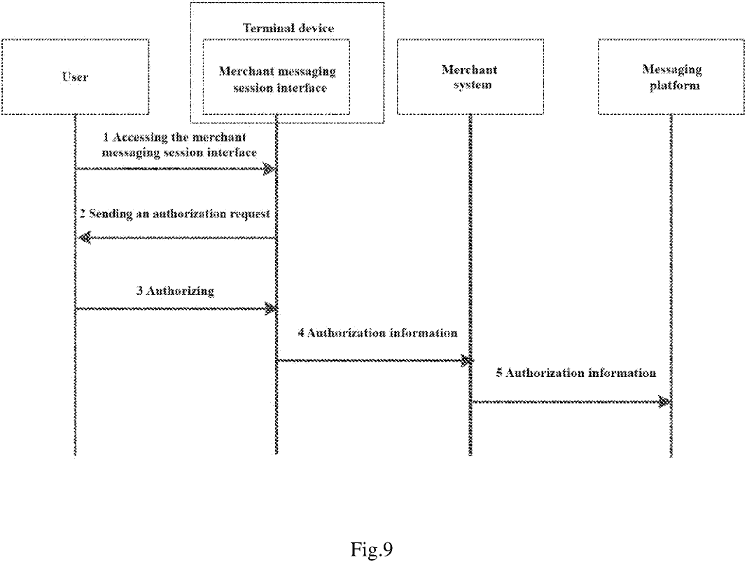

In order to improve the security of the transaction method, in some possible embodiments, the method of performing login verification and payment request pass-through verification at the messaging platform will be described below with reference to FIG. 8 and in conjunction with FIG. 9.

For the terminal device, the transaction method may further include following steps 101b to 104b.

Step 101b: acquiring authorization information. The authorization information includes: a communication account of the terminal device, identification information of the terminal device, and merchant account information of a user in the merchant system.

The communication account of the terminal device may for example be the cell phone number, and the identification information of the terminal device may for example be the cell phone serial number, the international mobile equipment identity (IMEI) code, the mobile equipment identification code (MEID), and the identification (ID) of the Bluetooth module in the cell phone. The merchant account may for example be the account name registered by the user on a shopping website. The above information can only be acquired after the authorization of the user. The user may for example click an “Authorize” button on the merchant messaging session interface.

Step 102b: sending the authorization information to the merchant system to enable the merchant system to send the authorization information to a messaging platform, such that the messaging platform stores the authorization information, where the communication between any two of the terminal device, the merchant system and the payment system is relayed by the messaging platform.

In order words, the merchant system informs the authorization information to the messaging platform, and the messaging platform records the authorization information and interconnects the information included therein.

Step 103b: reacquiring authorization information when the user logs into the merchant messaging session interface, and sending the re-acquired authorization information to the messaging platform for the messaging platform to perform login verification.

In other words, when the user logs into the merchant messaging session interface on the terminal device, he/she needs to reacquire the current communication account, the identification information of the terminal device and the merchant account information. Only when these communication account, the identification information and the merchant account information reacquired by the user are identical with the authorization information maintained on the messaging platform, the messaging platform will allow the user to log into the merchant system and to further make purchases and payments by transceiving the rich media message.

Step 104b: reacquiring authorization information upon sending the payment request in the rich media message format to the merchant system, and sending the reacquired authorization information to the merchant system to enable the merchant system to send the reacquired authorization information to the messaging platform, thereby allowing the messaging platform to perform payment verification.

In other words, when the user clicks a “Pay” button on the terminal device, the terminal device may reacquire and then send the current authorization information together with the payment request. When the payment request reaches the messaging platform and the subsequent node is the payment system, the messaging platform may verify whether the current authorization information is identical with the stored authorization information before passing through the payment request to the payment system (specifically, the payment request is firstly passed through to the payment gateway in embodiments of the present application).

Described above is to ensure the security of the payment, in order words, only the payment initiated by a specific cell phone number on a specific cell phone by a specific merchant account is the payment that can be processed.

Based on the same inventive concept, the operation of the merchant system according to embodiments of the present application further includes following steps:

receiving authorization information from the terminal device, and sending the authorization information to a messaging platform for the messaging platform to perform login verification, where the authorization information includes a communication account of the terminal device, identification information of the terminal device, and merchant account information of a user in the merchant system; and the communication between any two of the terminal device, the merchant system, and the payment system is relayed by the messaging platform.

In other words, the merchant system may firstly store the authorization information in the messaging platform, and when the user logs into the merchant system again (necessarily via the messaging platform), the messaging platform is able to verify the current authorization information.

Under a condition that the authorization information is stored in the messaging platform, the messaging platform may receive the new authorization information again when the merchant system passes through the payment request to the payment system (the merchant system receives the new authorization information at the same time), such that the messaging platform can verify the current authorization information (to determine whether it is identical with the previously stored authorization information).

All the described above is to improve the security.

Based on the same inventive concept, referring to FIG. 11, embodiments of the present application further provide a terminal device, which includes:

at least one first processor 1002, and a first memory 1001 communicatively connected to the at least one first processor 1002, where the first memory 1001 stores first instructions executable by the at least one first processor 1002, and the first instructions are executed by the at least one first processor 1002 to enable the at least one first processor 1002 to perform the above transaction method applicable to the terminal device.

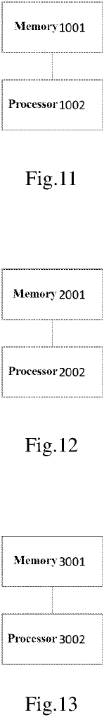

Based on the same inventive concept, referring to FIG. 12, embodiments of the present application further provide a payment system, which includes:

at least one second processor 2002, and a second memory 2001 communicatively connected to the at least one second processor 2002, where the second memory 2001 stores second instructions executable by the at least one second processor 2002, and the second instructions are executed by the at least one second processor 2002 to enable the at least one second processor 2002 to perform the above transaction method applicable to the merchant system.

Based on the same inventive concept, referring to FIG. 13, embodiments of the present application further provide a merchant system, which includes:

at least one third processor 3002, and a third memory 3001 communicatively connected to the at least one third processor 3002, where the third memory 3001 stores third instructions executable by the at least one third processor 3002, and the third instructions are executed by the at least one third processor 3002 to enable the at least one third processor 3002 to perform the transaction method applicable to the payment system.

Embodiments of the present application further provide a transaction system including the terminal device and the payment system.

Further, the transaction system further includes the above merchant system.

Further, the transaction system further includes: a messaging platform for processing the rich media message, and the messaging platform may perform login verification or payment verification in some embodiments.

Embodiments of the present application further provide a computer-readable storage medium storing programs that when executed by a processor, cause the processor to perform the transaction method applicable to the terminal device, the above transaction method applicable to the merchant system, or the above transaction method applicable to the payment system.

The respective embodiments of the present application are described in a progressive manner. The reference may be made to each other for the same or similar parts between the respective embodiments, and each embodiment focuses on the differences from other embodiments. In particular, for the embodiments of the device, apparatus and computer-readable storage medium, since they are substantially similar to the embodiments of the method, the description thereon is simplified, and reference may be made to the description part on embodiments of the method for relevant aspects.

The apparatus, system and computer-readable storage medium according to embodiments of the present application are in one-to-one correspondence. Thus, the apparatus, system and computer-readable medium have similar beneficial technical effects with the corresponding method. Since the beneficial technical effects of the method have been described in detail above, the beneficial technical effects of the apparatus, system and computer-readable storage medium will not be repeated here.

Those skilled in the art should understand that the embodiments of the present application may be provided as a method, a system, or a computer program product. Therefore, the present application may be in the form of full hardware embodiments, full software embodiments, or a combination thereof. Moreover, the present application may be in the form of a computer program product that is implemented on one or more computer-usable storage media (which includes, but is not limited to, magnetic disk storage, CD-ROM and optical storage) containing computer-usable program codes.

The present application is described referring to the flow chart and/or block diagram of the method, device (system) and computer program product according to the embodiments of the present application. It should be understood that, each flow and/or block in the flowchart and/or block diagram and the combination of flow and/or block in the flowchart and/or block diagram may be realized via computer program instructions. Such computer program instructions may be provided to the processor of a general-purpose computer, special-purpose computer, a built-in processor or other programmable data processing devices to produce a machine, such that the instructions executed by the processor of a computer or other programmable data processing devices may produce a device for implementing the functions specified in one or more flows in the flowchart and/or one or more blocks in the block diagram.

Such computer program instructions may also be stored in a computer-readable storage that can guide a computer or other programmable data processing devices to work in a specific mode, such that the instructions stored in the computer-readable storage may produce a manufacture including a commander equipment, where the commander equipment may realize the functions specified in one or more flows of the flowchart and one or more blocks in the block diagram.

Such computer program instructions may also be loaded to a computer or other programmable data processing devices, such that a series of operational processes may be executed on the computer or other programmable devices to produce a computer-realized processing, and thereby the instructions executed on the computer or other programmable devices may provide a process for realizing the functions specified in one or more flows in the flowchart and/or one or more blocks in the block diagram.

In a typical configuration, the computing device includes one or more processors (CPU), an input/output interface, a network interface, and a memory.

The memory may include a non-permanent memory in a computer-readable medium, a random-access memory (RAM) and/or a non-volatile memory, such as a read-only memory (ROM) or a flash memory (flash RAM). The memory is an example of a computer-readable medium.

The computer-readable medium may be permanent and non-permanent, or removable and non-removable media, which can achieve the information storage by any method or technology. The information may be computer-readable instructions, data structures, program modules, or other data. Examples of the computer storage medium include, but are not limited to, a phase change memory (PRAM), a static random-access memory (SRAM), a dynamic random-access memory (DRAM), other types of random-access memory (RAM), read-only memory (ROM), an electrically erasable programmable read-only memory (EEPROM), a flash memory or other memory technologies, a CD-ROM, a digital versatile disc (DVD) or other optical storage, and a magnetic cassette tape. The magnetic tape storage or other magnetic storage devices or any other non-transmission medium may be configured to store information that can be accessed by computing devices. Furthermore, although the operations of the method of the present application are described in a specific order in drawings, it does not require or imply that the operations should be performed in the specific order, or that the desired result can only be achieved if all the operations as shown are performed. Additionally, or alternatively, some steps may be omitted, multiple steps may be combined into one step for execution, and/or one step may be decomposed into multiple steps for execution.

Although the spirit and principles of the present application have been described with reference to several embodiments, it shall be understood that the present application is not limited to the embodiments as disclosed, nor does the division of the aspects imply that the features in those aspects cannot be combined for benefit, such division being for convenience of presentation only. The present application is intended to cover various modifications and equivalent arrangements included within the spirit and scope of the appended claims.

1. A transaction method applicable to a terminal device, comprising:
generating a payment request;
sending the payment request in a rich media message format to a payment system; and receiving a payment processing result in the rich media message format from the payment system, wherein the payment processing result corresponds to the payment request.

2. The transaction method according to claim 1, further comprising:
acquiring payment verification information, and sending the payment verification information in the rich media message format to the payment system, wherein the payment verification information corresponds to the payment request.

3. The transaction method according to claim 1, wherein generating the payment request comprises:
acquiring order-related information;
sending the order-related information in the rich media message format to a merchant system;
receiving order information in the rich media message format from the merchant system, wherein the order information is generated by the merchant system based on the order-related information; and
generating the payment request based on the order information;
wherein sending the payment request in the rich media message format to the payment system specifically comprises sending the payment request in the rich media message format to the merchant system to enable the merchant system to send the payment request to the payment system; and
wherein the transaction method further comprises: receiving from the merchant system an order processing result corresponding to the order information.

4. The transaction method according to claim 3, further comprising:
generating a first merchant identification code randomly;
determining an encryption key, and encrypting the first merchant identification code with the encryption key to acquire an identity code;
sending the identity code in the rich media message format to the payment system to enable the payment system to decrypt the identity code and thereby acquire a second merchant identification code, wherein the payment system is capable of decrypting the identity code; and
sending the order-related information in the rich media message format to the merchant system upon receiving a message that the identity code in the rich media message format sent by the payment system is successfully received;
wherein sending the payment request in the rich media message format to the merchant system to enable the merchant system to send the payment request to the payment system comprises: sending the payment request and the first merchant identification code in the rich media message format to the merchant system to enable the merchant system to send the payment request and the first merchant identification code to the payment system.

5. The transaction method according to claim 4, wherein
sending the order-related information in the rich media message format to the merchant system upon receiving the message that the identity code in the rich media message format sent by the payment system is successfully received specifically comprises: sending the order-related information and the identity code in the rich media message format to the merchant system upon receiving the message that the identity code in the rich media message format sent by the payment system is successfully received;
receiving the order information in the rich media message format from the merchant system specifically comprises: receiving the order information and the identity code in the rich media message format from the merchant system;
sending the payment request in the rich media message format to the merchant system to enable the merchant system to send the payment request to the payment system specifically comprises: sending the payment request, the first merchant identification code and the identity code in the rich media message format to the merchant system to enable the merchant system to send the payment request and the first merchant identification code to the payment system.

6. The transaction method according to claim 3, further comprising:
acquiring authorization information, wherein the authorization information comprises: a communication account of the terminal device, identification information of the terminal device, and merchant account information of a user in the merchant system;
sending the authorization information to the merchant system to enable the merchant system to send the authorization information to a messaging platform, such that the messaging platform stores the authorization information, wherein communication between any two of the terminal device, the merchant system and the payment system is relayed by the messaging platform; and
reacquiring authorization information when the user logs into the merchant system, and sending the reacquired authorization information to the messaging platform for the messaging platform to perform login verification.

7. The transaction method according to claim 3, further comprising:
acquiring authorization information, wherein the authorization information comprises: a communication account of the terminal device, identification information of the terminal device, and merchant account information of a user in the merchant system;
sending the authorization information to the merchant system to enable the merchant system to send the authorization information to a messaging platform, such that the messaging platform stores the authorization information, wherein communication between any two of the terminal device, the merchant system and the payment system is relayed by the messaging platform; and
reacquiring authorization information upon sending the payment request in the rich media message format to the merchant system, and sending the reacquired authorization information to the merchant system to enable the merchant system to send the reacquired authorization information to the messaging platform, thereby allowing the messaging platform to perform payment verification.

8. A transaction method applicable to a payment system, comprising:
acquiring a payment request in a rich media message format from a terminal device; processing the payment request, and acquiring a payment processing result; and
sending the payment processing result in the rich media message format to the terminal device.

9. The transaction method according to claim 8, further comprising:
acquiring payment verification information in a rich media message format from the terminal device, and verifying the payment verification information, wherein the payment verification information corresponds to the payment request; and
processing the payment request under a condition that the payment verification information passes verification.

10. The transaction method according to claim 8, further comprising:
acquiring from the terminal device an identity code corresponding to the payment request, and decrypting the identity code to acquire a second merchant identification code; and
comparing a first merchant identification code carried in the payment request with the second merchant identification code, and processing the payment request under a condition that the first merchant identification code is identical with the second merchant identification code, wherein acquiring the payment request in the rich media message format from the terminal device comprises acquiring the payment request in the rich media message format and the first merchant identification code from the terminal device.

11. The transaction method according to claim 8, further comprising:
acquiring from the terminal device an identity code corresponding to the payment request, and decrypting the identity code to acquire a second merchant identification code; and
decrypting the identity code carried in the payment request to acquire a third merchant identification code, comparing the merchant third identification code with a first merchant identification code carried in the payment request and the second merchant identification code, and processing the payment request under a condition that the third merchant identification code, the first merchant identification code and the second merchant identification code are identical, wherein acquiring the payment request in the rich media message format from the terminal device comprises acquiring the payment request in the rich media message format, the first merchant identification code and the identity code from the terminal device.

12. A transaction method applicable to a merchant system, comprising:
acquiring order-related information in a rich media message format from a terminal device;
generating order information based on the order-related information, and sending the order information in the rich media message format to the terminal device;
acquiring from the terminal device a payment request in a rich media message format corresponding to the order information;
sending the payment request to a payment system;
acquiring from the payment system a payment processing result corresponding to the payment request; and
processing the order information based on the payment processing result, and sending the acquired order processing result in a rich media message format to the terminal device.

13. The transaction method according to claim 12, wherein
acquiring from the terminal device the payment request in the rich media message format corresponding to the order information comprises: acquiring from the terminal device the payment request in the rich media message format and a first merchant identification code corresponding to the order information; and
sending the payment request to the payment system comprises: sending the payment request and the first merchant identification code to the payment system.

14. The transaction method according to claim 12, wherein
acquiring the order-related information in the rich media message format from the terminal device comprises: acquiring the order-related information in the rich media message format and an identity code from the terminal device;
sending the order information in the rich media message format to the terminal device comprises: sending the order information and the identity code in the rich media message format to the terminal device;
acquiring from the terminal device the payment request in the rich media message format corresponding to the order information comprises: acquiring from the terminal device the payment request in the rich media message format corresponding to the order information, the first merchant identification code and the identity code; and
sending the payment request to the payment system comprises: sending the payment request, the first merchant identification code and the identity code to the payment system.

15. The transaction method according to claim 12, further comprising:
receiving authorization information from the terminal device, and sending the authorization information to a messaging platform for the messaging platform to perform login verification, wherein the authorization information comprises a communication account of the terminal device, identification information of the terminal device, and merchant account information of a user in the merchant system, and communication between any two of the terminal device, the merchant system, and the payment system is relayed by the messaging platform.

16. The transaction method according to claim 12, further comprising:
receiving authorization information from the terminal device, and sending the authorization information to a messaging platform for the messaging platform to perform payment verification, wherein the authorization information comprises a communication account of the terminal device, identification information of the terminal device, and merchant account information of a user in the merchant system, and communication between any two of the terminal device, the merchant system, and the payment system is relayed by the messaging platform;
wherein sending the payment request to the payment system comprises: sending the payment request and the authorization information to the messaging platform for the messaging platform to verify the authorization information and send the payment request to the payment system under a condition that the authorization information passes verification.

17. A terminal device, comprising:
at least one first processor, and a first memory communicatively connected to the at least one first processor; wherein the first memory stores first instructions executable by the at least one first processor, and the first instructions are executed by the at least one first processor to enable the at least one first processor to perform the transaction method according to claim 1.

18. A payment system, comprising:
at least one second processor, and a second memory communicatively connected to the at least one second processor; wherein the second memory stores second instructions executable by the at least one second processor, and the second instructions are executed by the at least one second processor to enable the at least one second processor to perform the transaction method according to claim 8.

19. A merchant system, comprising:
at least one third processor, and a third memory communicatively connected to the at least one third processor; wherein the third memory stores third instructions executable by the at least one third processor, and the third instructions are executed by the at least one third processor to enable the at least one third processor to perform the transaction method according to claim 12.

20-22. (canceled)
